(19) United States
(12) Patent Application Publication
(10) Pub. No.: US 2020/0407146 A1
(43) Pub. Date: Dec. 31, 2020

(54) DISPOSABLE HEATING CAN FOR DRINKS OR FOOD

(71) Applicant: Ecan Inc., Van Nuys, CA (US)

(72) Inventors: Alexander Winter, Van Nuys, CA (US); Peter Schultz, Chatsworth, CA (US); Sharon Winter, Van Nuys, CA (US)

(21) Appl. No.: 16/856,931

(22) Filed: Apr. 23, 2020

Related U.S. Application Data
(60) Provisional application No. 62/872,536, filed on Jul. 10, 2019.
(60) Provisional application No. 62/867,072, filed on Jun. 26, 2019.

(51) Int. Cl. B65D 81/34; H05B 3/00; H05B 1/02

(52) U.S. Cl. CPC B65D 81/3476; H05B 1/0236; H05B 3/0019

(57) ABSTRACT

A disposable container for food or beverage has a resistive heating element and a temperature sensor, where electric power is applied to the heating element which generates heat used to warm the container and its contents. A processor monitors the container and content temperature using a signal from the temperature sensor, and controls the temperature of the container and content using a switch circuit, so that the temperature is raised to a preset level, and then the electrical power is removed from the heating element.

### CROSS-REFERENCE TO RELATED APPLICATIONS

This application claims priority to U.S. Provisional Patent Application Ser. No. 62/872,536, entitled “Disposable and Non-Disposable Heating and Cooling Can/Container/Bottle Containing Drinks or Food” which was filed on Jul. 10, 2019, and U.S. Provisional Patent Application Ser. No. 62/867,072 entitled “Disposable Heating Can for Drinks or Food” which was filed on Jun. 26, 2019 the full disclosures of which are incorporated herein by reference for all purposes.

### BACKGROUND

Prepacked containers of food and drink provide easy access, but they are generally at room temperature, where the food or drink may be more palatable if the contents are warmed or heated before consumption, without being taken out of the container. In many instances the prepacked containers are disposable, but some are also intended for reuse. These prepacked containers are particularly useful when away from home or traveling, but they may be similarly intended for use in the home. Systems and methods are needed to warm or heat food or drink in the container they are delivered in before consumption, without removing them from the container.

The preceding description is not to be construed as an admission that any of the description is prior art relative to the present invention.

### SUMMARY OF THE INVENTION

According to the various features disclosed herein, a system and method comprises an electrical connection to an external direct current power supply, where the electrical connection is removable. A voltage converter receives a first current at a first voltage from the external direct current power supply and provides a second current at a second voltage different from the first voltage. A processor receives the second current at the second voltage from the voltage converter. A heating element connection receives the first current at the first voltage. A switch connection receives a signal representing a heating profile from the processor. A temperature sensor connection receives a signal representing content temperature in a container, and provides the signal to the processor. A light emitting diode controlled by the processor indicates heating status. Program code that is executed by the processor controls the signal representing the heating profile to raise temperature of the content in the container to a predetermined temperature by connecting the first current at the first voltage to a heating element using a switch connected to the switch connection, and then preventing further heating by isolating the first current at the first voltage from the heating element using the switch connected to the switch connection.

In the system and method, the external direct current power source is typically 12 volts DC from a cigarette lighter plug. In the system and method, the external direct current power source is converted from 110 or 220 volts AC. In the system and method, the electrical connection to the external direct current power source is a cigarette lighter plug. In the system and method, the temperature sensor connection is a magnetic connection and a curie temperature of the magnetic connection is 160 degrees F. or less. In the system and method, the voltage converter is a step-down converter that outputs 5 volts DC. In the system and method, the voltage converter is a step-down converter that outputs 3.3 volts DC. In the system and method, the processor is one of a MicroChip PIC12FXXX series, Atmel AtTiny series, Cypress PSOC 4xxx family and Holtex HT66F0021. In the system and method, the switch connection controls a direct current controlled relay. In the system and method, the switch connection controls a MOSFET. In the system and method, the heating element connection and the temperature sensor connection are integrated into a single connection.

A disposable container includes an inner metal wall, an outer insulating layer, a heating element that is disposed between the inner metal wall and the outer insulating layer, a heating element connection electrically connected to the heating element, a temperature sensor positioned to contact the inner metal wall to sense temperature of content in the container and generate a temperature signal, a temperature sensor connection electrically connected to the temperature sensor, and a switch.

In the disposable container, the inner metal wall is aluminum. In the disposable container, the heating element is one of nichrome (NiCr), KANTHAL (a ferritic iron-chromium-aluminium alloy), cupronickel (CuNi), or copper. The heating element itself may be deposited on or included as part of an insulating layer such as a copper layer on polyimide. In the disposable container, the processor is electrically connected to the temperature sensor with program code that is executed by the processor, where the program code controls the switch based on the temperature signal, to raise temperature of content in the container to a predetermined temperature by connecting a first current at a first voltage to the heating element connection, and then preventing further heating by isolating the first current at the first voltage from the heating element. In the disposable container, the switch is a MOSFET.

The foregoing specific aspects are illustrative of those which can be achieved and are not intended to be exhaustive or limiting of the possible advantages that can be realized. Thus, the objects and advantages will be apparent from the description herein or can be learned from practicing the invention, both as embodied herein or as modified in view of any variations which may be apparent to those skilled in the art. Accordingly the present invention resides in the novel parts, constructions, arrangements, combinations and improvements herein shown and described.

### BRIEF DESCRIPTION OF THE DRAWINGS

The foregoing features and other aspects of the invention are explained in the following description taken in conjunction with the accompanying figures wherein:

FIG. 1 illustrates an example of a system according to one embodiment;

FIG. 2 illustrates an example of a system according to one embodiment;

FIG. 3 illustrates an example of an electronic device according to one embodiment;

FIG. 4 illustrates an example of an electronic device according to one embodiment;

FIG. 5 illustrates an example of an electronic device according to one embodiment;

FIG. 6 illustrates an example of an electronic device according to one embodiment;

FIG. 7 illustrates an example of an electronic device according to one embodiment;

FIG. 8 illustrates an example of a heating profile according to one embodiment;

FIG. 9 illustrates an example of a heating profile according to one embodiment;

FIG. 10 illustrates steps in an example method for the system according to one embodiment;

FIG. 11 illustrates examples of an electronic device according to various embodiments;

FIG. 12 illustrates examples of an electronic device according to various embodiments; and

FIG. 13 illustrates examples of an electronic device according to various embodiments.

It is understood that the drawings are for illustration only and are not limiting.

### DETAILED DESCRIPTION OF THE DRAWINGS

The system includes a device that has a removable connection to a direct current (DC) source, such as a cigarette lighter socket in a vehicle. Depending on the application, the connection to the DC source might be a cigarette lighter plug. The device includes a processor that executes program code, and the program code receives temperature data from a temperature sensor. The temperature sensor senses temperature of contents in a container, and based on the temperature the processor switches DC power that is used to heat the container, and contents.

Cigarette lighter sockets in vehicles are generally limited to a maximum amperage, and are protected by a fuse or circuit breaker. If the circuit has a maximum amperage of 20 amps at 12 volts, then the maximum power available is 240 watts (20 amps*12 volts). That power can be used to operate the processor and other components, as well as heat contents of the container, such as through a resistive heating element that surrounds the container.

A cigarette lighter socket may be limited to significantly less than 20 amps, such as 5 amps. In this instance, the power available is reduced, but even with reduced power, the available power will serve to heat contents of the container.

Because the system may also be used in the home environment, where a cigarette lighter plug is not available, a 112 volts AC, or 220 volts AC connection can also be used, with either a conversion to 12 volts DC, or the AC voltage may be converted to a different voltage, either AC or DC.

Single Use and Multiple Use Containers

In many cases, the container and contents are intended for a single use, meaning that they are to be heated, consumed shortly after heating, and after consumed the used container is discarded. In such a case, it may be appropriate to include features that will enforce the single use. Those features might be integrated into the container, or they might be integrated into the container and other external components.

For example, some sort of fuse or switch might be activated after a single use heating cycle is completed, and once that fuse or switch has been activated, the container is prevented from activating a second heating cycle. Examples of such a fuse or switch include a thin trace on a circuit board that is burned through with a burst of energy. It is also possible to use something like a software controlled DIP switch, or non-volatile reference voltage where one voltage or DIP switch setting represents the device has not been through a heating cycle and can be heated and then used, and a second different voltage or DIP switch setting represents that the device has been through a heating cycle and is not to be used again.

If the container is to be used for multiple heating cycles, then a counter reflecting the number of completed heating cycles might be included to prevent the device from being used beyond its intended number of heating cycles.

Configurable Heating Profiles

When containers all include the same contents or type of contents, a single heating profile might be appropriate, and there is no need for the system to know what type of container or contents are being heated. However, it is also possible that a heating profile should be selectable based on the container and/or contents. For example a coffee beverage might be heated to a temperature that is suitable for hot coffee and once that temperature has been reached, the heating element is disconnected. The temperature for a coffee beverage is probably too hot for baby food, which needs to be heated to and then held at a different and lower temperature. For example a coffee beverage might be heated to 160 degrees F., while the baby food might be heated to 90 degrees F. Depending on how warm the contents are heated, the size of the container, and the voltage/current supplied, it may take 4 to 10 minutes for the contents to reach a desired temperature.

There are multiple ways different heating profiles might be implemented. It could be that a user must enter a code that is printed on the outside of the container, where that code tells the system what heating profile should be used. This configuration would depend on the user entering the correct code, and there might be no safety checks.

Another configuration might poll or interrogate the container when the container is initially plugged in, and get a coded response back from the container, where the coded response identifies the container, content, and/or heating profile. The coded response could also indicate that the container is a multi-use container. Identification of the container or contents could be provided using the temperature sensor, where the initial value of the temperature sensor is used to identify the container/contents.

Arrangement or Configuration of Components

The various components of the system can be located in or on different parts. As one example, to minimize the number of electronic components that are discarded with the container after use, the container might have a heating element, and a temperature sensor, with electrical connections to both. All other components of the system could be located in one or more components that are not discarded after use. Those other components might all be integrated into a cigarette lighter plug with a single connection to the container. Or the other components might be in a separate enclosure that has one connection to a cigarette lighter plug, and another connection to the container.

It is also possible that almost all components are attached to or integrated into the container, with only an electrical connection to an external 12 volt power source. This configuration might be appropriate where the container is intended for multiple uses, and not discarded after a single use.

Temperature Sensor

In most applications, it is important to monitor the temperature of contents in the container, and control the heating cycles, based on that temperature. In most instances, the temperature is monitored by a temperature sensor that is integrated into or attached to the outside of the container. Temperature sensors are generally passive resistive elements, and exhibit a changing resistance based on the temperature. There is usually a calibration curve or direct relationship between the resistance and measured temperature. However, a direct measurement of resistance is difficult, and usually a voltage drop across the resistance is measured, and that voltage drop is converted to the temperature using a mathematical formula. Because the measured voltage drop across the temperature sensor is analog, meaning that it varies continuously between a low and high value, the analog voltage value cannot be used directly by a micro-processor. Instead, the analog voltage value must be converted to a digital value that represents the voltage drop and similarly the measured temperature. Typically this conversion from analog to digital is accomplished with an Analog-to-Digital Conversion (ADC) chip. An ADC is generally an active device, meaning that it requires power to operate, where the power is supplied at standard voltages, such as 3.3 volts, or 5.0 volts. Location of the ADC either directly on the container, or remote from the container, will determine how many connections to/from the container might be required to monitor the temperature. The analog voltage can be carried on a single pair conductor. Depending on the signaling protocol, a digital signal can be carried on one or more conductors, but the ADC will also require power, so generally locating the ADC on the container means that at least 3 conductors might be required (one+conductor, one−conductor, and one signal conductor).

Processor

There are a number of low-cost and low power micro-processors available. These devices often include non-volatile data storage for both software code, as well as data. These devices might also include ADC capabilities allowing direct analog input without a separate ADC. There are also a number of standard communication protocols that may be fully integrated into the processor, such as Serial TxRx, I2C, or SPI.

Examples of the type of processors that might be appropriate include: MicroChip PIC12FXXX series, Atmel AtTiny series, Cypress PSOC 4xxx family and Holtex HT66F0021.

Heating Element

Any material that conducts electricity can be a heating element, because they exhibit resistance to the flow of electricity and that resistance generates heat. Some materials are more suitable as heating elements, maybe because they are more efficient, or they are easier shape or form during manufacture, or they are lower cost. Some materials that are commonly used for high-temperature applications, might not be suitable for a lower-temperature application. Examples of materials for resistive heating elements include: nichrome (NiCr), KANTHAL, cupronickel (CuNi), and copper.

For this particular application, an etched or sputtered thin copper layer that is deposited on a flexible substrate has some advantages. It is relatively low-cost to manufacture, the pattern of the element can be adjusted or designed to fit a particular container, or container content, and the heating element is relatively low cost. In addition, if a single-use container is desired, a fuse element can be etched or sputtered at the same time and included on the same substrate as the heating element. It is also possible to design certain areas of the patterned copper layer with different layer thickness and/or trace width, so that the heat generated by those areas is either greater or less than the heat generated by other areas. In this way, the heat can be somewhat concentrated in particular areas of the container.

Power Switching

For applications where a simple on-off control will provide the desired heating profile, the selection of an appropriate switch may be fairly simple. As an example, a DC activated solenoid could easily handle a 240 watt power switching requirement, without significant loss. However, a solenoid might be too large to attach directly to a container, and it might be more expensive, so it would be more appropriate to include a DC activated solenoid inside a component that is not discarded. A solid state relay would have some of the same advantages, although the cost might be a factor.

Using pulse-width-modulation (PWM) it is possible to provide both an on-off switch, and a variable heating rate. Where the maximum heating rate is desired, there may be no PWM, and the driver circuit is active continuously. When a less than maximum heating rate is desired, the PWM features are used to rapidly switch the current on/off, and provide reduced power to the heating element. PWM control of a heating element is known, and may be provided by a MOSFET. One of the down-sides of PWM control is that there is some energy loss in the PWM circuit, and that energy loss generates heat. It may be helpful to use some of that generated heat in the actual content heating, so attaching the PWM circuit to the container provides some advantages. By attaching the PWM circuit to the container, excess heating on other components can be minimized. A PWM circuit attached to a container generally requires both the heating circuit, as well as a control circuit. If the PWM circuit is located in conjunction with the processor and remote from the container, then only a heating circuit is needed from the PWM circuit to the container.

Heating Status and Feedback

As heat is applied to a container and associated contents, the container will get warmer until the desired temperature is reached. Even when the container is thermally insulated, that heat will probably be detectable by touch. However, just because the container is warm to the touch does not mean it has reached the intended temperature and the contents are ready for consumption. It is therefore help to provide some type of heating status indicator, either on the container itself or on some other component. One or more light emitting diodes (LEDs) can provide that type of heating status indication. One LED color might indicate that the container is receiving power and has begun the heating profile. A second LED color might indicate that the container has reached the target or set point temperature, and the heating element has been turned off. A third LED color might indicate that the container has already been through one heating cycle and the one-time use circuit has been activated, and the container is not available for further heating.

The LEDs might be attached to the container, and discarded with the container, or they might be incorporated into other system components. Depending on what they are being used to indicate, LEDs might be located on multiple components.

Identification of Container and Contents

Where only one type of content are envisioned, and a single heating profile is appropriate for that type of content, the system can be designed to provide only one heating profile. If more than one type of content is envisioned, and those different types of content require different heating profiles, then some method for identification of the content is needed. As an example, a hot coffee beverage, might require heating to a temperature that is almost hot enough to scald. By contrast, baby food would require heating to a much lower temperature. In addition, maintaining the baby food at that temperature for a length of time might be suitable, which the coffee beverage only needs to be heated to the desired temperature, and then heating can be stopped.

For these and other reasons, it may be advantageous for the system to be able to identify a container and/or its contents when it is first connected. Then, based on the identification of container/contents, an appropriate heating profile can be used.

Container Materials

Metals, such as aluminum are good heat conductors, they are relatively inert to most foods or beverages, and they are reasonably inexpensive and are recyclable. For all of these reasons, an aluminum container is a good choice. Other suitable metals include steel, and stainless steel. Glass is also a good heat conductor and it is relatively inert. Glass is also recyclable, and can be relatively inexpensive. However, untreated glass may not be suitable for use in a container that will be heated, because thermal expansion may fracture the glass. Organic materials, such as paper, although not particularly good heat conductors, exhibit thermal insulative properties, so have advantages for an outer covering, or when combined with other materials. Plastics also have some advantages, but where higher levels of heat are applied, they may suffer from loss of strength or actually melt unless they are combined with other materials.

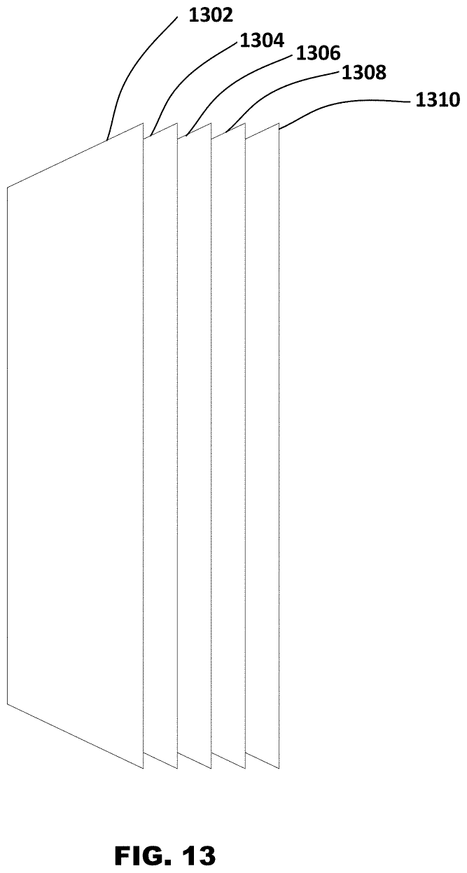

Referring to FIG. 13, the container wall may include multiple layers. In this example an inner layer 1302 is in contact with the container contents. This inner layer 1302 might be a relatively inert material such as polyethylene. There might be more than one such inner polyethylene layer. Next at 1304, might be a thin metallic layer, such as aluminum. The aluminum layer enhances thermal conduction and depending on how thick the layer is, provides some additional strength. Another polyethylene layer 1306 may help bond the aluminum layer 1304 to a paperboard layer 1308. The paperboard layer may be significantly thicker than the other layers and it may provide a majority of the strength in the container. On the outer surface may be another polyethylene layer 1310, which helps to seal the paperboard layer, and also provides a moisture barrier, to keep the paperboard from absorbing moisture. This type of multi-layer packaging is commercially available, an example being packaging from TETRA PAK.

Thermal Insulative Covering Materials

Because an object is to heat the contents in the container, and the heating element is attached to the outside of the container, the container itself will get as hot as or hotter than the contents. This may be warmer than can be comfortably held in the hand, so some sort of thermal insulative covering is appropriate. As indicated above, a paper or fiber layer might be appropriate for this purpose. Other materials, such as polyimides which can be applied by spray or dip coating may be particularly advantageous because of their heat resistance. Natural latex, synthetic latex, neoprene, Poly Vinyl Chloride (PVC) and other similar materials are also suitable materials. The paperboard layer 1308 illustrated in FIG. 13 is an example of a thermal insulative covering material.

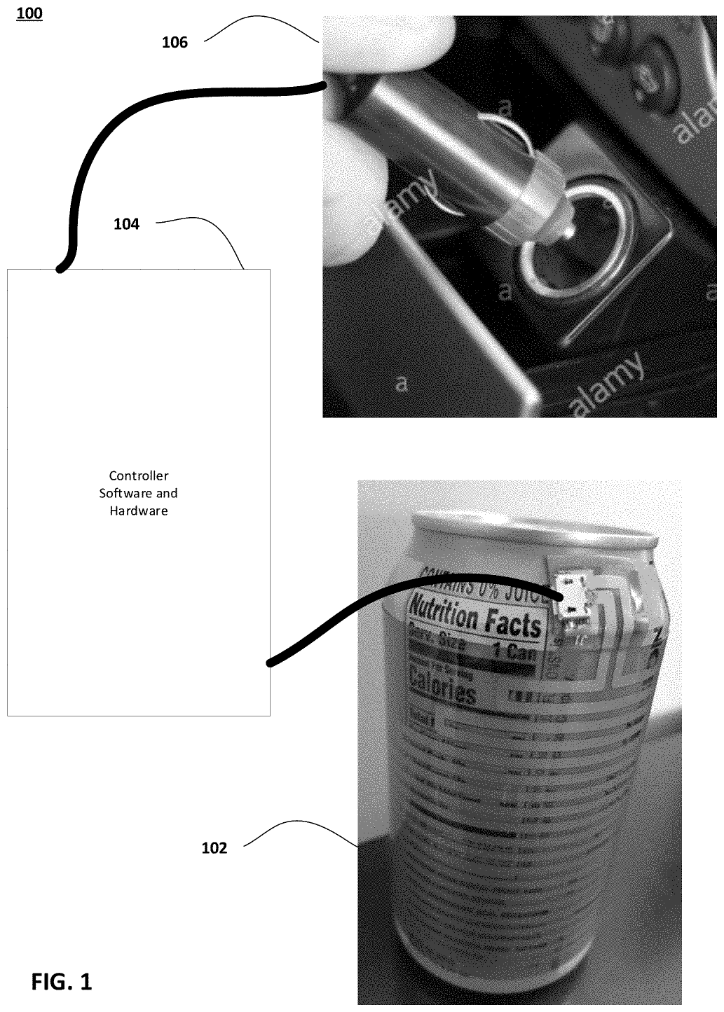

These and other features are illustrated in the Figures. Referring to FIG. 1, a system 100 includes a container 102, where the container 102 is connected to a control unit 104. The control unit 104 has an electrical connection to a power source, such as a 12 volt DC cigarette lighter plug 106. Control unit 104 includes both hardware components, as well as software or computer code. The connection between container 102 and control unit 104 is removable, such as with a plug that has multiple electrical inter-connections. Although not illustrated in FIG. 1, the cigarette lighter plug 106 may have a light emitting diode (LED) to show that the system is being powered by the 12 volt DC. There may also be one or more LEDs at the connection between container 102 and control unit 104 to show that power is applied, the unit is heating, the desired temperature has been reached, and/or other aspects.

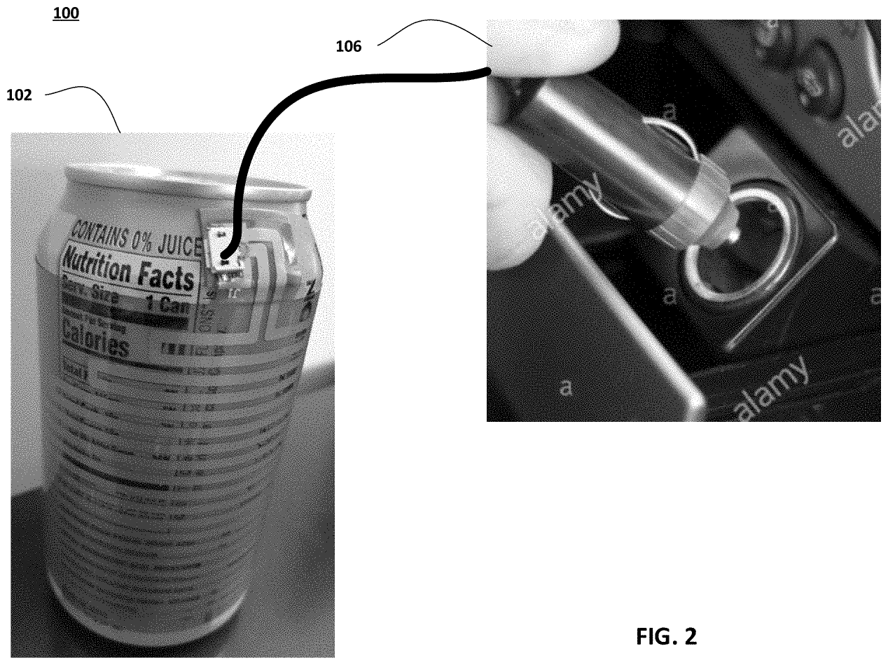

As illustrated in FIG. 2, it is also possible to integrate the components of control unit 104 into cigarette lighter plug 106 and/or container 102.

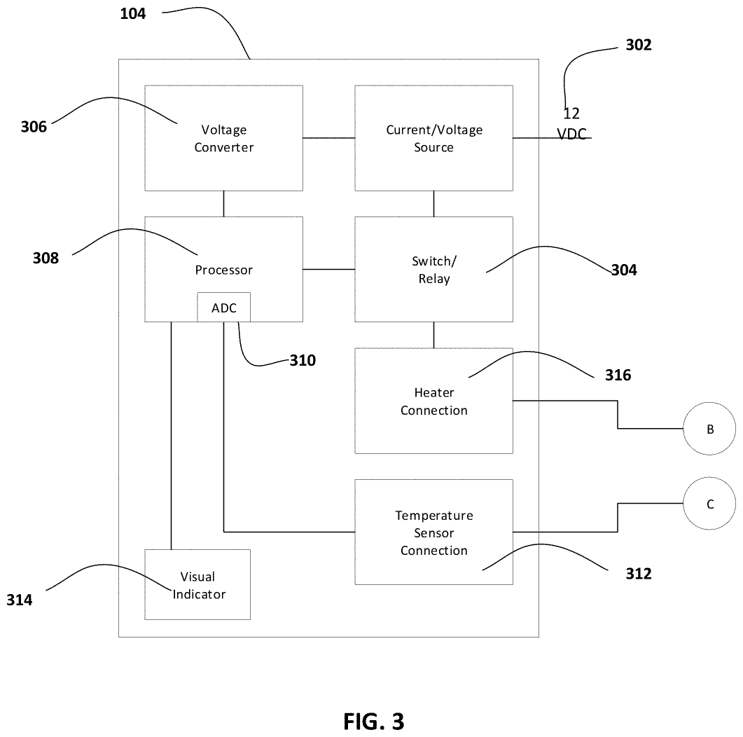

FIG. 3 illustrates one configuration of control unit 104, where connection 302 provides input power in the form of 12 volts DC from a cigarette lighter plug. The input power is made available to a switch/relay 304, and a voltage converter 306. Controlling the amount of power that is sent to container 102 is made possible by use of a switch/relay 304. Control unit 104 also includes a processor 308, and many commercial processors require less than 12 volts. A voltage converter 306 serves to change the 12 volt input to a voltage required by processor 308. In many cases the processor requires one or both of 5.0 volts, and 3.3 volts. Processor 308 is generally entirely digital, meaning that is operates on +/− signals having respective values of 1 or 0. Analog signals must be converted to digital signals before they can be used by digital processors. Some processors include an integrated analog-digital circuit (ADC) 310. Other processors require a separate ADC to process analog values.

One of the input signals that processor 308 operates on is a signal that represents the temperature of container 102 and the contents of container 102. The temperature signal input to control unit 104 is through a temperature sensor connection 312. Where the signal received from the temperature sensor is an analog signal, the signal might be a voltage drop across the temperature sensor, and ADC 310 converts that voltage drop to a digital signal that can be used by processor 308.

To provide status or feedback to a user, processor 308 may also illuminate one or more light emitting diodes (LEDS) 314.

Finally, processor 308 controls heating of container 102 by switching power on and off to the heating element. The switching is accomplished by switch/relay 304 and the switched power is provided to container 102 through heater connection 316.

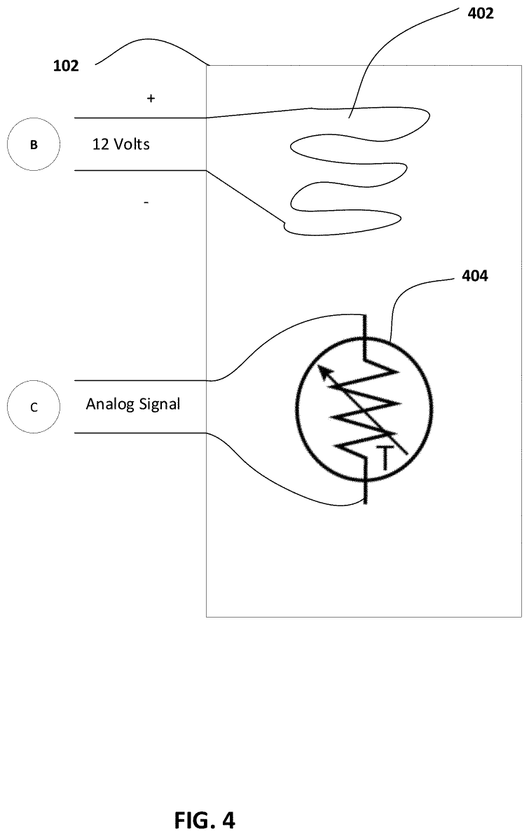

As illustrated in FIG. 4, container 102, has a heating element 402 that is wrapped around the outside of container 102. Heating element 402 is electrically connected to control unit 104 through heater connection 316. A temperature sensor 404 is also attached to the outside of container 102. Temperature sensor 404 is electrically connected to control unit 104 through temperature sensor connection 312. The resistance of the temperature sensor varies with temperature and a voltage drop across the sensor represents that temperature.

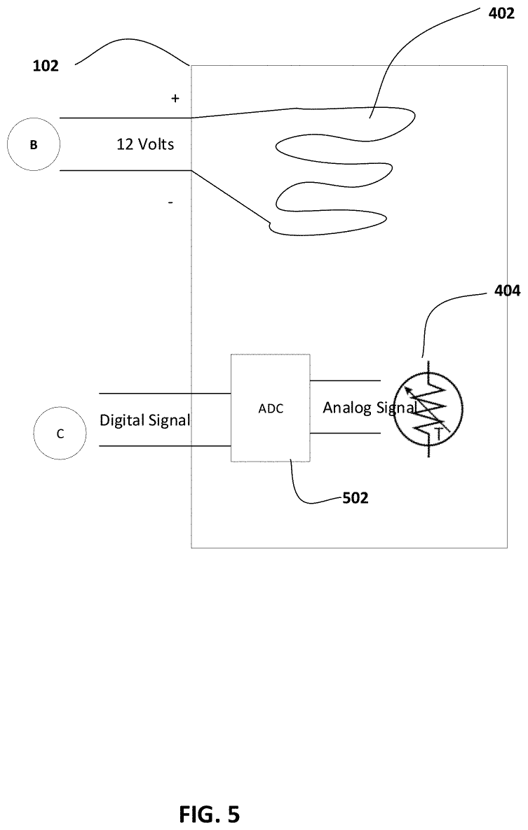

As illustrated in FIG. 5, an ADC 502 might be physically integrated with or connected to temperature sensor on container 102. This might have advantages where processor 308 does not already have an integrated ADC. Although an ADC is not a passive device, and it requires a power source to convert the voltage drop across temperature sensor 404 to a digital value, the power requirement of the ADC may be sufficiently low that a simple voltage divider circuit with two resistors might be able to convert the 12 volts DC that is used to heat the container down to either 5.0 or 3.3 volts as needed by the ADC. In this way, the number of power/signal conductors between control unit 104 and container 102 can be reduced.

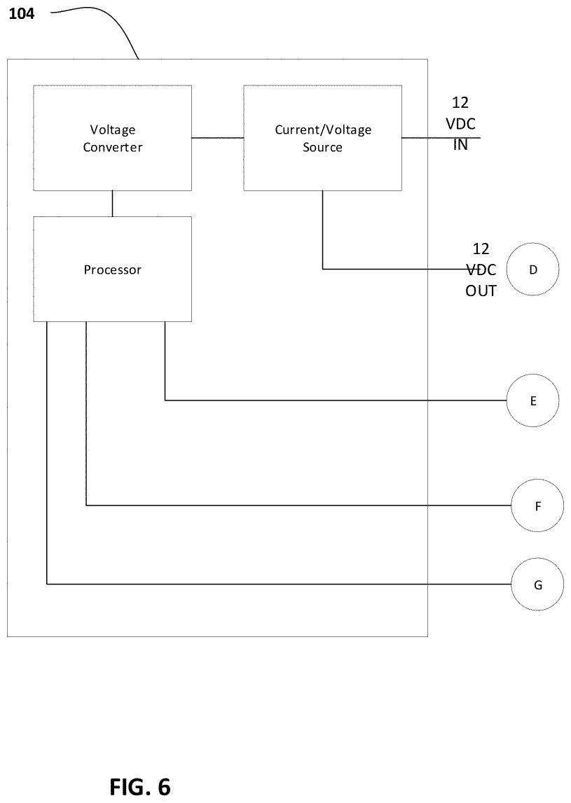

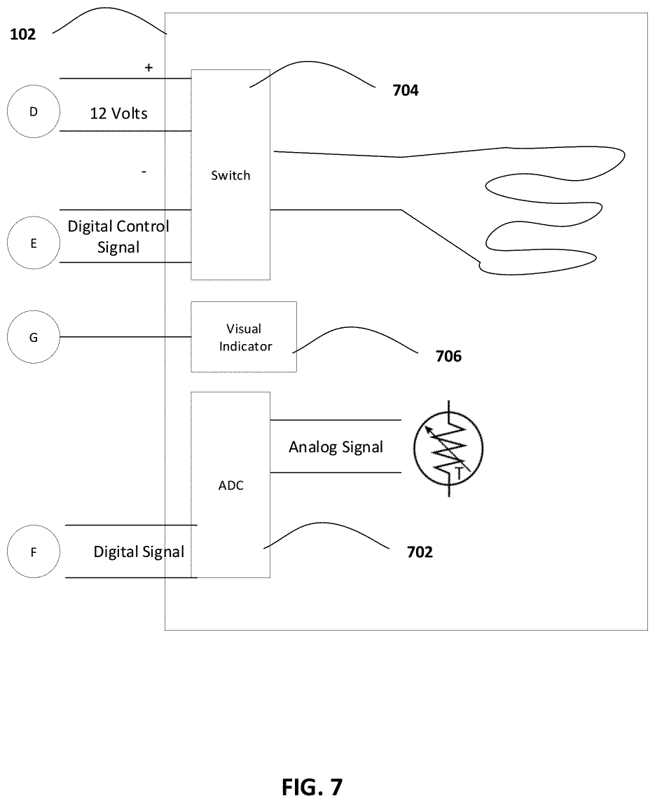

It is also possible, as illustrated in FIGS. 6 and 7, to move more components from control unit 104 to container 102. In this configuration, the ADC 702 is on the container, along with the visual indicator 706, and the switch/relay 704. In this configuration, processor 308 is maintained in control unit 104, along with voltage converter 306. By moving more components to container 102, there may be some advantages. For instance, if switch/relay 704 is a PWM circuit, the heat generated by the PWM circuit can be used to heat the contents of container 102, instead of being wasted. Further, by locating the visual indicator 706 on the container itself, a user may have better feedback on actual status of the contents. Finally by moving ADC 702 to the container it may be possible to use a single data connection between control unit 104 and container 102. That single data connection might be something like I2C or SPI, with the different signals for visual indicator, heating control and temperature all multiplexed on that single data connection. In addition, those different signals could all be digital signals.

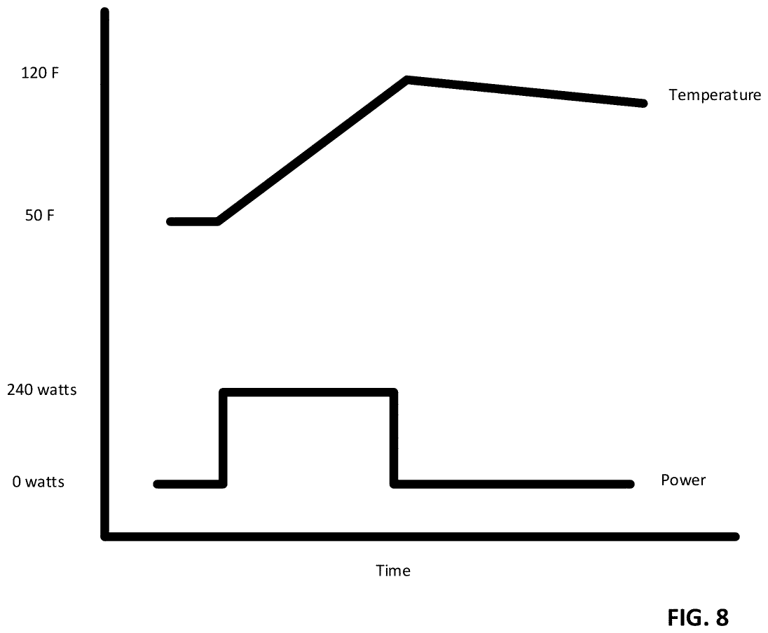

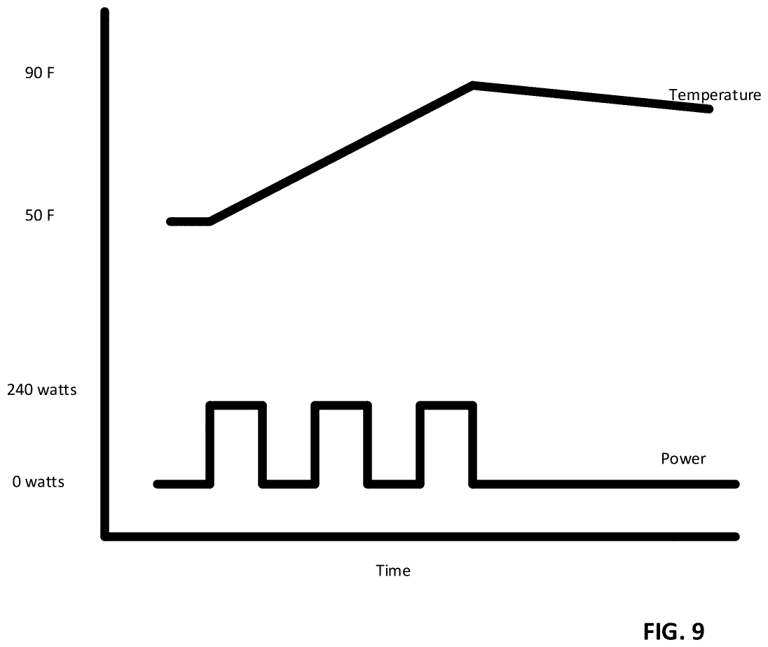

As illustrated in FIGS. 8 and 9, it is possible to provide different heating profiles. In FIG. 8, power to the heating element is either on, or off. During the time that power is applied to the heating element, temperature of the contents of the container will increase. When power is removed from the heating element, the temperature of the contents of the container will slowly decrease, as heat is lost to the surroundings. In FIG. 9, power to the heating element is turned on and off intermittently. This is how PWM can be used to provide a variable heating profile. The PWM circuit adjusts the respective on and off time, with the resulting temperature rise being controlled.

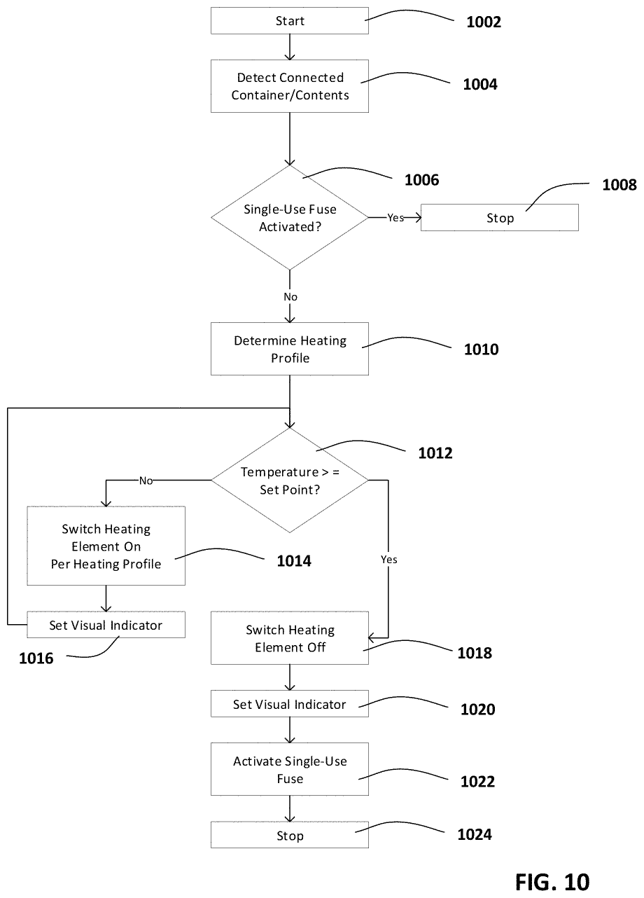

FIG. 10 illustrates example steps in a method for use of system 100. At 1002, system 100 starts. This could be simply plugging the cigarette lighter plug into the 12 volts DC receptacle of a vehicle to energize the circuits.

At 1004, system 100 detects any connected container and identifies their contents. This is not required, but might be appropriate where different contents require different heating profiles.

At 1006, system 100 determines whether any single-use fuse or circuit has been activated. This is not required, but may be appropriate to prevent re-heating of container 102 after the initial heating cycle. Although not illustrated, this could also be a check of multi-use limits, such as where a container may be reused, but the number of reheat cycles is limited.

If the single-use fuse or circuit has been activated, system 100 stops at 1008 and no heating occurs.

If the single-use fuse or circuit has not been activated, at 1010, system 1010 determines the appropriate heating profile. Although changeable heating profiles are not required, they might be appropriate where different contents require different heating profiles. Regardless, some type of heating profile is selected.

At step 1012, system 100 determines whether the set point temperature has been reached, and if that set point temperature has not been reached, then at 1014 system 100 switches the heating element on according to the desired heating profile. The heating profile could be to apply the maximum amount of power available, as illustrated in FIG. 8, or it could be to modulate the amount of power applied, as illustrated in FIG. 9.

As the heating progresses, system 100 also sets a visual indicator at step 1016. This visual indicator might be an LED of a particular color, such Yellow or Red to indicate that the system is heating.

Once system 100 determines that the desired temperature set point has been reached at step 1012, then at step 1018 switches the heating element off, and at 1020 sets a visual indicator of the completed heating cycle. This visual indicator might be an LED of a different color, such Green to indicate that the container and contents have been heated to the desired temperature.

If the container 102 is a single-use container, then at 1022, system 100 activates a single-use fuse and at step 1024 the system stops.

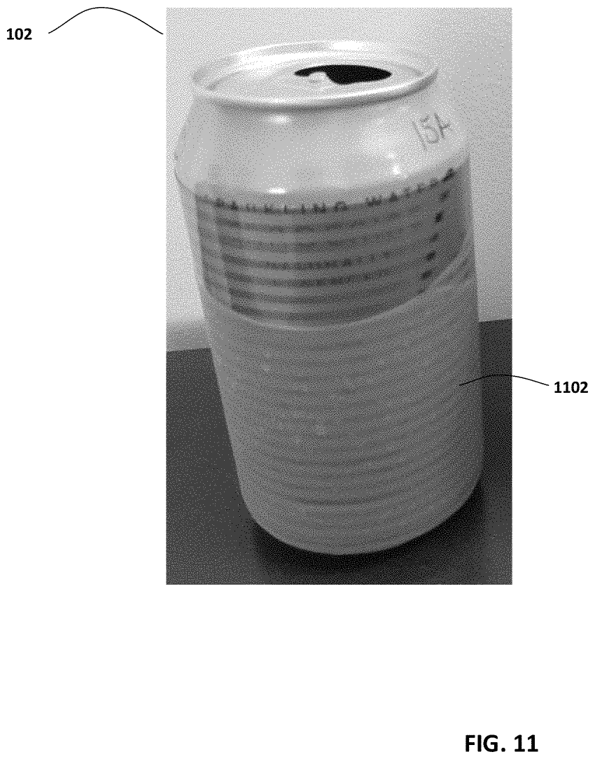

The insulative outer layer over container 102 may be a polyimide that is applied by dip or spray. FIG. 11 illustrates an example of container 102 with such an insulative outer layer 1102.

Connector

Some components are intended for reuse, and some components are intended for single use. These components must be electrically connected. There are multiple possible connections. One connection is a mating plug, such as a USB plug. A USB connector provides multiple electrical connections that can be used for DC power, and control or signaling. A USB plug provides some resistance to removal.

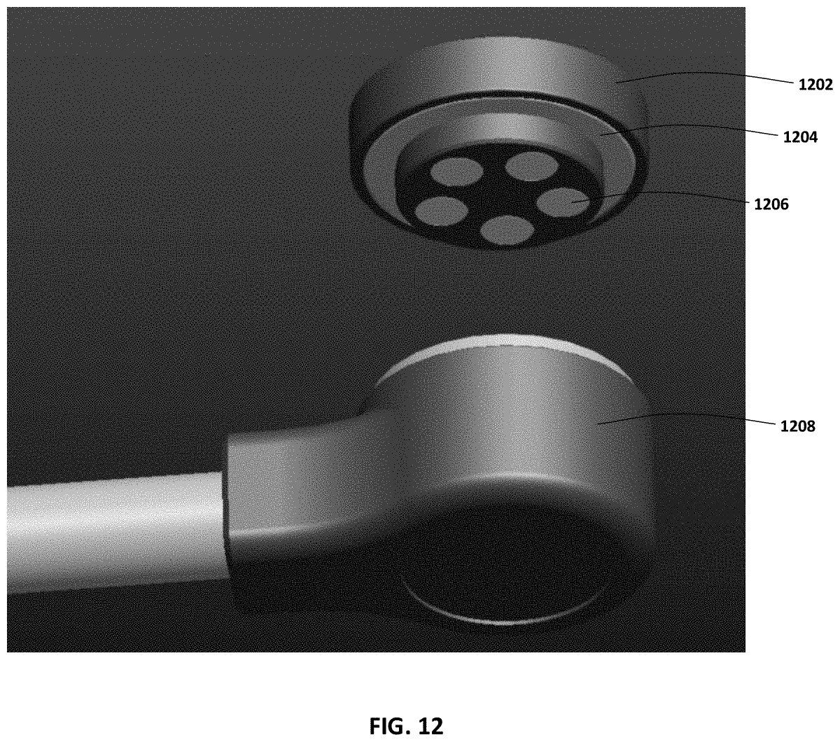

Referring to FIG. 12, magnetic connectors provide an alternative type of plug, where the two connectors are held together by one or more magnets. One of the connectors (1202) is attached to the container, and the other connector (1208) is attached to a cable which connects to control unit 104. The one or more magnets 1204 and connectors 1206 on connector 1202 cooperate with similar magnets and connectors (not illustrated) on connector 1208. Use of a magnetic connector provides some advantages. The connectors can easily separate, without damage if they are pulled apart, something that might not be possible with other connectors such as USB. In addition, magnets generally exhibit a property where their magnetism is reduced or disappears when the temperature goes above a threshold temperature. This is often referred to as the curie point or curie temperature. By selecting a magnetic material with a curie temperature of about 140 degrees, the connector between control unit 104 and container 102 can be broken at a specific temperature, cutting off the heating current. This provides a level of additional safety, where the container does not readily continue to heat above the desired set point. The physical disconnect can also be sensed by the processor and that can be used to signal that heating is completed.

Although illustrative embodiments have been described herein in detail, it should be noted and will be appreciated by those skilled in the art that numerous variations may be made within the scope of this invention without departing from the principle of this invention and without sacrificing its chief advantages. For example features that appear in one embodiment of a particular figure are also applicable to embodiments that are illustrated in other figures.

Unless otherwise specifically stated, the terms and expressions have been used herein as terms of description and not terms of limitation. There is no intention to use the terms or expressions to exclude any equivalents of features shown and described or portions thereof and this invention should be defined in accordance with the claims that follow.

1. A device comprising:
an electrical connection to an external direct current power source, the electrical connection being removable;
a voltage converter, receiving first current at a first voltage from the external direct current power source, and providing second current at a second voltage different from the first voltage;
a processor, receiving the second current at the second voltage from the voltage converter;
a heating element connection, receiving the first current at the first voltage;
a switch connection, receiving a signal representing a heating profile from the processor;
a temperature sensor connection, receiving a signal representing content temperature in a container, and providing the signal to the processor;
a light emitting diode controlled by the processor, indicating heating status; and
program code executed by the processor, the program code controlling the signal representing the heating profile, the program code to raise temperature of the content in the container to a predetermined temperature by connecting the first current at the first voltage to a heating element using a switch connected to the switch connection, and then prevent further heating by isolating the first current at the first voltage from the heating element using the switch connected to the switch connection.

2. The device of claim 1, wherein the external direct current power source is 12 volts DC from a cigarette lighter socket.

3. The device of claim 1, wherein the external direct current power source is converted from 110 or 220 volts AC.

4. The device of claim 1, wherein the electrical connection to the external direct current power source is a cigarette lighter plug.

5. The device of claim 1, wherein the temperature sensor connection is a magnetic connection and a curie temperature of the magnetic connection is 160 degrees F. or less.

6. The device of claim 1, wherein the voltage converter is a step-down converter that outputs 5 volts DC.

7. The device of claim 1, wherein the voltage converter is a step-down converter that outputs 3.3 volts DC.

8. The device of claim 1, wherein the processor is selected from the group including MicroChip PIC12FXXX series, Atmel AtTiny series, Cypress PSOC 4xxx family and Holtex HT66F0021.

9. The device of claim 1, wherein the switch connection controls a direct current controlled relay.

10. The device of claim 1, wherein the switch connection controls a MOSFET.

11. The device of claim 1, wherein the heating element connection and the temperature sensor connection are integrated in a single connection.

12. A disposable container, comprising.
an inner metal wall;
an outer insulating layer;
a heating element disposed between the inner metal wall and the outer insulating layer;
a heating element connection electrically connected to the heating element;
a temperature sensor positioned to contact the inner metal wall to sense temperature of content in the disposable container and generate a temperature signal;
a temperature sensor connection electrically connected to the temperature sensor; and
a switch.

13. The disposable container of claim 12, wherein the inner metal wall is aluminum.

14. The disposable container of claim 12, wherein the heating element is selected from the group that includes nichrome (NiCr), KANTHAL, cupronickel (CuNi), and copper.

15. The disposable container of claim 12, wherein the heating element includes a patterned copper layer on a flexible polyimide layer.

16. The disposable container of claim 12, further comprising:
a processor electrically connected to the temperature sensor with program code executed by the processor, the program code controlling the switch based on the temperature signal, the program code to raise temperature of content in the disposable container to a predetermined temperature by connecting a first current at a first voltage to the heating element connection, and then prevent further heating by isolating the first current at the first voltage from the heating element connection.

17. The disposable container of claim 12, wherein the switch is a MOSFET.
